(19) United States
(12) Patent Application Publication
(10) Pub. No.: US 2016/0246761 A1
(43) Pub. Date: Aug. 25, 2016

(54) METHOD FOR QUICKLY INSERTING WORDART IN PDF DOCUMENT

(71) Applicant: Fujian Foxit Software Development Joint Stock Co., Ltd., Fuzhou (CN)

(72) Inventor: Xiaolong Fan, Beijing (CN)

(21) Appl. No.: 14/778,165

(22) PCT Filed: Mar. 7, 2014
(86) PCT No.: PCT/CN2014/000210

§ 371 Date: Sep. 18, 2015

(30) Foreign Application Priority Data
Mar. 19, 2013 (CN) 201310088371.5

(51) Int. Cl. G06F 17/21; G06T 11/60; G06F 17/24; G06F 3/0354; G06F 3/0484; G06F 3/0482

(52) U.S. Cl. CPC G06F 17/214; G06F 3/04842; G06F 3/0482; G06F 17/24; G06F 3/04847; G06F 3/03543; G06T 11/60; G06F 17/248

(57) ABSTRACT

Disclosed is a method for quickly inserting Wordart in a PDF document. The method comprises the following steps: S1: establishing Wordart attribute libraries containing various Wordart models, wherein Wordart attributes define concrete expression forms of Wordart; S2: establishing Wordart model libraries, wherein the Wordart model libraries correspond to the Wordart attribute libraries one-by-one for a user to select in the form of a list as required; and S3: when the user selects one of the Wordart models therein, popping up an editing window for the user to write the content of the Wordart to be inserted, then adding the attribute corresponding to the Wordart model onto the content written by the user, and integrating the content of the Wordart to be inserted and the attribute and then writing same in a PDF document. By means of the present invention, the purpose of quickly inserting Wordart can be achieved, thereby improving the working efficiency for people to process a PDF document.

### TECHNICAL FIELD

The present invention relates to a technical field of editing PDF document, and particularly to a method for quickly inserting Wordart in a PDF document.

### BACKGROUND

In the PDF and other format documents, for the beautiful, personalized display effect, the characters of the document are often processed artistically by the user, so as to meet multiple aspects of the aesthetic needs. In the existing technologies, the operation of inserting Wordart is more complex, the various kinds of restrictions of attributes should be added to the inserted text for each Wordart to be inserted, which include the displaying of position, size, status, rotation angle, etc., it takes long time for waiting when the user operates, and so it is unfavorable for improving the efficiency.

### SUMMARY OF THE INVENTION

In view of the defects of complex operation, slowly processing, long waiting time during inserting Wordart in the existing technologies, the purpose of the present invention is to provide a method for quickly and easily inserting Wordart in a PDF document.

In order to achieve the above purpose, the present invention provides a method for quickly inserting Wordart in a PDF document, which comprises the following steps of:

S1: Establishing Wordart attribute libraries containing various Wordart models, wherein Wordart attributes define concrete expression forms of Wordart;

S2: Establishing Wordart model libraries, wherein the Wordart model libraries respond to the Wordart attribute libraries one-by-one for a user to select in the form of a list as required;

S3: When the user selects one of the Wordart models therein, popping up an editing window for the user to write the content of the Wordart to be inserted, then adding the attribute corresponding to the Wordart model onto the content written by the user, and integrating the content of the Wordart to be inserted and the attribute and then writing same in a PDF document.

A method for quickly inserting Wordart in a PDF document provided by the present invention, wherein, said Wordart attribute libraries include the self-defined Wordart attribute libraries, which provide the self-defined Wordart for the user when the needed Wordart model cannot be found in the list.

A method for quickly inserting Wordart in a PDF document provided by the present invention, wherein, said self-definition of Wordart comprises the steps of:

S11: The user sets the expression forms of the self-defined Wordart by mean of the path constraint;

S12: Setting the additive attributes containing conventional or general artistic effect for said self-defined Wordart;

S13: Denominating the self -defined Wordart and setting the preview typefaces;

S14: Completing the self-defined Wordart and saving the relevant information to the self-defined WordArt attribute libraries.

A method for quickly inserting WordArt in a PDF document provided by the present invention, wherein, said path constraint comprises: the user drags a mouse to draw the rendering path of the Wordart, or determine one curve path by choosing the specific function and setting the parameters of the function.

A method for quickly inserting WordArt in a PDF document provided by the present invention, wherein, said Wordart to be inserted contains multiple characters and each character is processed separately as one object.

A method for quickly inserting WordArt in a PDF document provided by the present invention, wherein, said path constraint is described by the specific function, and the value range of variables in said function is not specified, then the Wordart characters are arranged in the path according to the interval of the characters in normal document, and the path is terminated at the last character.

Compared with the existing technologies, the beneficial effect of the present invention lies in that: setting in advance the desired effect object, wherein the character string section is left as a blank, and the attribute information is saved as a mode of template, the contents filled by the user are assigned to the blank section to form a new object to be inserted into the file when the uses invokes said template, which results in quickly inserting Wordart.

### DESCRIPTION OF THE DRAWINGS

FIG. 1 is a flow diagram of a method for quickly inserting Wordart in a PDF document in the present invention;

FIG. 2 is a flow diagram of self-defined Wordart in the present invention.

FIG. 3 is a form of the path constraint of the polar coordinates curve.

### DETAILED DESCRIPTION OF THE EMBODIMENTS

With reference to the accompanying drawings, the technical solution of embodiments of the present invention will be described clearly and entirely, the given embodiments are only part of the embodiments of the present invention not all of the embodiments obviously. Based on the embodiments of the present invention, all of the other embodiments which can be obtained without paying a creative work by those skilled in the art should be deemed to be within the scope of the present invention.

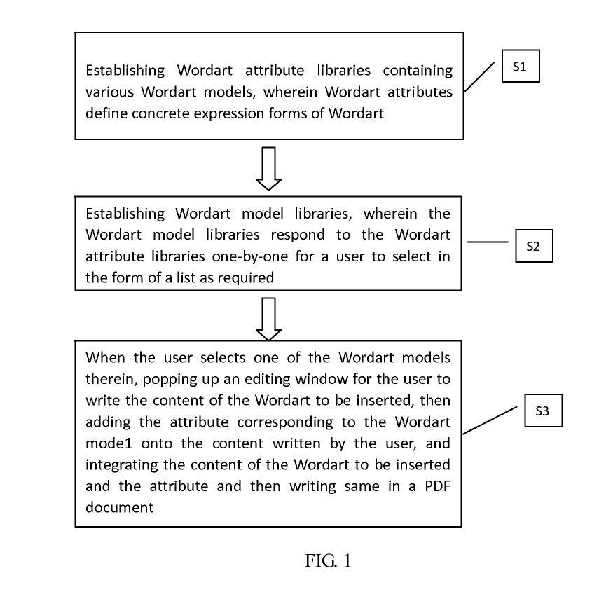

Referring to FIG. 1, which is a flow diagram of a method for quickly inserting Wordart in a PDF document in the present invention. As shown in FIG. 1, the present invention mainly comprises the following steps of:

S1: Establishing Wordart attribute libraries containing various Wordart models, wherein Wordart attributes define concrete expression forms of Wordart. The Wordart attribute libraries of the present invention covers all kinds of common effects of the Wordart, such as hollow out, shadow, gradient, and other forms.

S2: Establishing Wordart model libraries, wherein the Wordart model libraries respond to the Wordart attribute libraries one-by-one for a user to select in the form of a list as required. This step is actually the embodiment of each of the Wordart attributes in step S1, which can let the user vividly see the display effect of the various kinds of Wordart when opening the list, without remembering the exact attributes of all kinds of effects, thereby facilitate the operation for the user.

S3: when the user selects one of the Wordart models therein, popping up an editing window for the user to write the content of the Wordart to be inserted, then adding the attribute corresponding to the Wordart model onto the content written by the user, and integrating the content of the Wordart to be inserted and the attribute and then writing same in a PDF document.

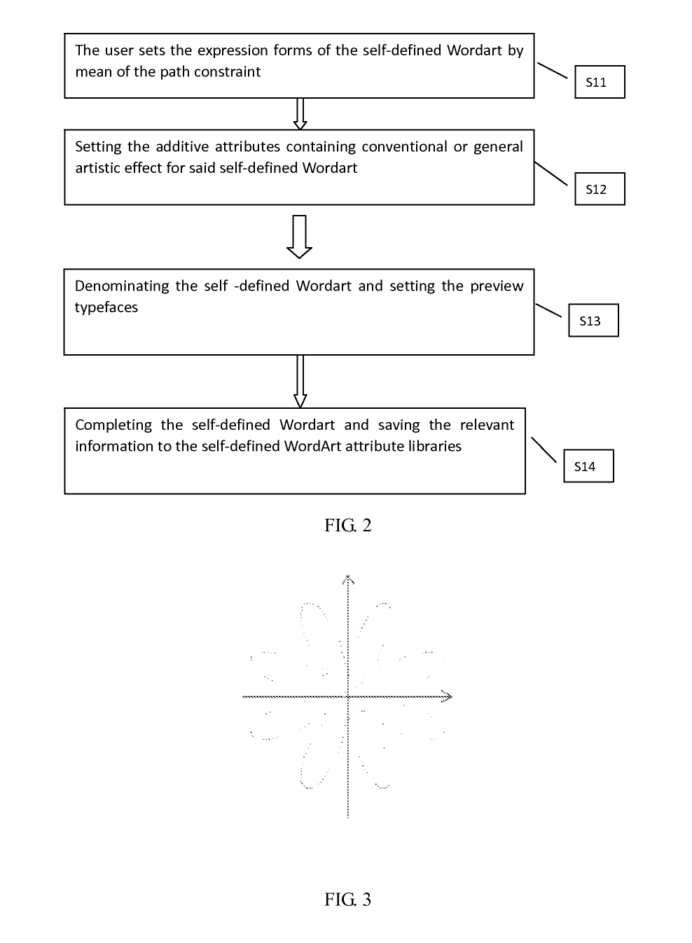

In addition, because the imagination of the human is endless, and the aesthetic standards are also various, the present inventors add the self-defined Wordart attribute libraries based on the original Wordart attribute libraries after considering sufficiently the above-mentioned point, which provides the self-defined Wordart for the user when the needed Wordart model cannot be found in the list. The above-mentioned self-definition of Wordart comprises the following steps of, as shown in FIG. 2:

S11: The user sets the expression forms of the self-defined Wordart by mean of the path constraint;

S12: Setting the additive attributes containing conventional or general artistic effect for said self-defined Wordart;

S13: Denominating the self -defined Wordart and setting the preview typefaces;

S14: Completing the self-defined Wordart and saving the relevant information to the self-defined WordArt attribute libraries.

Wherein, the path constraint comprises: the user drags a mouse to draw the rendering path of the Wordart, or determine one curve path by choosing the specific function and setting the parameters of the function, such as that shown as sine curve, polar coordinates curves (as shown in FIG. 3), or shown as the style of the dashboard, and etc.

After determining the path constraint, the conventional WordArt attributes, such as the effects of hollow out, gradient, shadow, can be added to the self-defined WordArt, so as to increase aesthetics.

It should be noted that, if the path is described by a concrete function and the user does not specify the value range of the variables in the function (that is: unable to get the path length), then the WordArt characters are arranged in the path according to the interval of the characters in normal documents, and the path is terminated at the last character. Otherwise, if the user has specified the length of the path, then the WordArt character will be evenly distributed in the path.

While implementing, for the WordArt with path constraint, each character inputted by the user is processed separately as one object, and the final position of each character object is determined combining with the path and the number of characters. Whether the character is tilted or not and the tilt direction depend on the position of the WordArt character in the path. After the position is determined, firstly the coordinates of current position should be taken, and then the coordinates of the point which is very close to the current coordinates and in the front of the path where the current coordinates located should be taken, and the inclination of the characters is determined according to the slope of the straight line formed by two points.

The above-mentioned is merely illustrative description of the present invention, and is not intended to limit the invention; those skilled in the art can understand that within the spirit and principle defined by the claims of present invention, the present invention of any modification, equivalent replacement, improvement, and so on should be deemed to be within the scope of the present invention.

What is claimed is:

1. A method for quickly inserting Wordart in a PDF document, comprising the following steps of:
S1: Establishing Wordart attribute libraries containing various Wordart models, wherein Wordart attributes define concrete expression forms of Wordart;
S2: Establishing Wordart model libraries, wherein the Wordart model libraries respond to the Wordart attribute libraries one-by-one for a user to select in the form of a list as required;
S3: when the user selects one of the Wordart models therein, popping up an editing window for the user to write the content of the Wordart to be inserted, then adding the attribute corresponding to the Wordart model onto the content written by the user, and integrating the content of the Wordart to be inserted and the attribute and then writing same in a PDF document.

2. The method for quickly inserting Wordart in a PDF document according to claim 1, wherein, said Wordart attribute libraries include the self-defined Wordart attribute libraries, which provide the self-defined Wordart for the user when the needed Wordart model cannot be found in the list.

3. The method for quickly inserting Wordart in a PDF document according to claim 2, wherein, said self-definition of Wordart comprises the steps of:
S11: The user sets the expression forms of the self-defined Wordart by mean of the path constraint;
S12: Setting the additive attributes containing conventional or general artistic effect for said self-defined Wordart;
S13: Denominating the self -defined Wordart and setting the preview typefaces;
S14: Completing the self-defined Wordart and saving the relevant information to the self-defined WordArt attribute libraries.

4. The method for quickly inserting Wordart in a PDF document according to claim 3, wherein, said path constraint comprises: the user drags a mouse to draw the rendering paths of the Wordart, or determine one curve path by choosing the specific function and setting the parameters of the function.

5. The method for quickly inserting Wordart in a PDF document according to claim 4, wherein, said Wordart to be inserted contains multiple characters and each character is processed separately as one object.

6. The method for quickly inserting Wordart in a PDF document according to claim 4, wherein, said path constraint is described by the specific function, and the value range of variables in said function is not specified, then the Wordart characters are arranged in the path according to the interval of the characters in normal document, and the path is terminated at the last character.
